(19) United States
(12) Patent Application Publication
(10) Pub. No.: US 2003/0233761 A1
(43) Pub. Date: Dec. 25, 2003

(54) Measuring device

(76) Inventor: Craig Mathew Erskine-Smith, New South Wales (AU)

Correspondence Address: Bell, Boyd & Lloyd LLC, P.O. Box 1135, Chicago, IL, 60690-1135, US

(21) Appl. No.: 10/420,202

(22) Filed: Apr. 22, 2003

(30) Foreign Application Priority Data
Apr. 22, 2002 (AU) PS1876

(51) Int. Cl. A61C 19/04

(52) U.S. Cl. 33/513

(57) ABSTRACT

A dental measuring device in the form of a caliper includes a pair of elongate jaws, each having an abutment surface. The jaws are movable between a first zero position wherein the abutment surfaces are contiguous with each other and a second position wherein the abutment surfaces are displaced from each other, this displacement defining a measured distance. A distal end of each jaw and includes an arrowhead formation wherein the arrowheads at least partially overlap when the jaws are in the first position.

### BACKGROUND OF THE INVENTION

The present invention relates to a length measuring device and a method of making the device.

The invention has been developed primarily for use in dentistry and will be described hereinafter with reference to this application. However, it will be appreciated that the invention is not limited to this particular field of use and is applicable to other fields in measuring the distance between two points or between the centres of holes and crevices.

In the dental profession, it has long been necessary to measure the gaps between a patient's teeth, distance between a fissure or hole in a tooth and the edge of a tooth, or other length properties of interest to the dentist. Previously used devices for measuring dental properties included simple draughting compasses which have a pair of spike members at one end. The spike members were aligned with the dental properties of interest, for example, the distance between a crack in a tooth and an upper or side edge of a tooth. The separation of the spike members corresponds to the property of interest and the measured distance is determined by overlaying the spike members on a ruler of the like and the length determined.

This method suffered from the inherent disadvantage that errors of significant magnitude occurred in the measurements due to the need to overlay the spike members on a ruler or other means of measuring the distance. This inaccuracy of these known devices increases as the measured distance decreases.

To overcome the need to transpose the spacing of the compass spike members onto a ruler or the like, calipers having a vernier or digital display have been used. Although being far more accurate than the draughting compass type device, the calipers require measurements to be made from the inside face of the calipers which introduced a measurement error corresponding to at least the thickness of one of the jaws. That is, the jaws were of a thickness that did not allow accurate measurement by the inner faces of the caliper jaws when measuring the distance between the centres of two holes or crevices, or other dental properties of interest.

In the case of non-dental applications where the distance between the centres of small crevices or fissures and holes are required, the calipers again can only be used to provide an estimation of the distance due to the thickness of the caliper jaws. In practice, the caliper jaw edges are transposed over the crevice or fissures and holes to provide an indication of the spacing therebetween. As with the draughting compass, this device is inadequate when the distance between the centres of small holes or crevices are required, and particularly when the generally small distances between the centres of small holes or crevices in dentistry applications are required.

### SUMMARY OF THE INVENTION

It is an advantage of the invention to provide a measuring device which at least ameliorates some of the aforementioned deficiencies in the art.

According to a first aspect of the invention there is provided a measuring device having a pair of elongate jaws each including an inner abutment surface, the jaws being movable between a first position wherein the inner abutment surface of the jaws are contiguous with each other and define a position of zero separation of the jaws and a second position wherein the jaws are displaced from each other, the distance the jaws being displaced from each other defining a measured distance, the measuring device being characterised by a distal end of each jaw having an arrowhead formation extending in the direction of elongation of the jaws wherein the tip of each arrowhead formation is aligned with a respective abutment surface and when the jaws are in the first position the arrowheads at least partially overlap so that the tips overlie each other.

In preferred embodiments of the invention, the arrowhead formation is configured to possess an acute angle substantially within the range of 2° to 70° and preferably 17°. More preferably, the width of each arrowhead formation is substantially within the range of 0.3 mm to 7 mm.

In some embodiments of the invention the measuring device is in the form of a caliper wherein the proximal end of the jaws are attached to the caliper to allow the movement of the distal end of the jaws between the first and second positions.

An elongate stem is also preferably included and has the first jaw disposed at a first end, the jaw being substantially perpendicular to the direction of elongation of the stem and the second jaw being slidably mounted on the elongate stem to allow movement of the second jaw relative to the first jaw and between the first and second jaw positions.

The measuring device preferably has a vernier scale indicative of the measured distance, the device including a first scale being disposed on the elongate stem and a second scale being disposed on the proximal end of the second jaw, wherein the relative position of the first and second scales provides an indication of the measured distance. Alternatively, the measuring device includes a digital display which is indicative of the measured distance.

Preferably, the arrowhead tips are each configured to be self-centring in a hole, crevice, fissure or the like wherein the measured distance is indicative of the distance between the centres of the hole, crevice, fissure or the like.

According to a second aspect of the invention there is provided an arrowhead formation according to the first aspect of the invention, the method including the steps of:

adding a predetermined volume of material on the distal end of an otherwise conventional jaw;

shaping said volume of material to define the arrowhead formation wherein the tip of the arrowhead formation is aligned with the abutment surface of the jaw.

Preferably the step of shaping the volume of material to define the arrowhead occurs by selectively grinding the material. Alternatively, the step of shaping the volume of material includes machining or pressing the volume.

Additional features and advantages of the present invention are described in, and will be apparent from, the following Detailed Description of the Invention and the Figures.

### BRIEF DESCRIPTION OF THE FIGURES

Preferred embodiments of the invention will now be described, by way of example only, with reference to the accompanying drawings in which:

FIG. 1 is a plan view of a measuring device in accordance with a preferred embodiment;

FIG. 2 is an enlarged plan view of the jaws of the device of FIG. 1;

FIG. 3 is an enlarged plan view of the device of FIG. 1 with the jaws in the first position;

FIG. 4 is a plan view of the jaws of FIGS. 3 when viewed from the end;

FIG. 4A is an enlarged view of FIG. 4 illustrating the overlapping of the arrow tips;

FIG. 5 is a plan view of another embodiment with the jaws in the second position;

FIG. 6 is a plan view of the embodiment of FIG. 5 with the jaws in the first position;

FIG. 7 is a plan view of another embodiment in which the jaws are in the first position;

FIG. 8 is a plan view of the embodiment of FIG. 7 with the jaws in the second position;

FIG. 9 is a plan view of an alternative embodiment when viewed from the end;

FIG. 9A is an enlarged view of FIG. 9 illustrating the overlapping of the arrow tips;

FIG. 9B is a plan view from the side of the embodiment of FIG. 9; and

FIG. 10 is a plan view of another embodiment with the jaws in the first position.

### DETAILED DESCRIPTION OF THE INVENTION

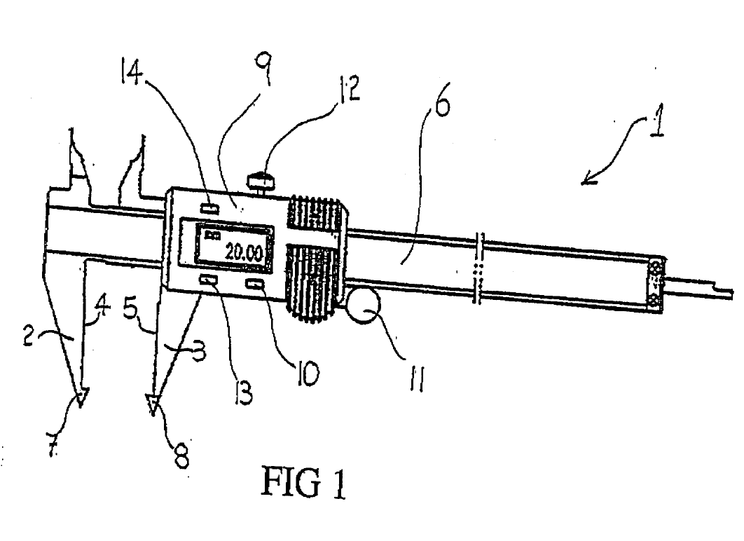

Referring to FIG. 1, there is illustrated a measuring device in the form of a caliper 1. The caliper includes a pair of elongate jaws 2 and 3 which each have an abutment surface 4 and 5.

The measuring device further includes an elongate stem 6 having the jaw 2 disposed at a first end. The jaw 2 is disposed substantially perpendicular to the direction of elongation of the stem 6. A proximal end of the second jaw 3 is slidably mounted along the elongate stem 6 to allow movement of the jaw 3 relative to the jaw 2.

The jaw 3 is movable relative to jaw 2 between a first position wherein the inner abutment surfaces 4 and 5 of the jaws 2 and 3 abut with each other and define a position of zero separation of the jaws, and a second position wherein the jaws 2 and 3 are displaced from each other, as illustrated in FIG. 1. The distance the jaw abutment surfaces 4 and 5 are displaced from each other defines a measured distance.

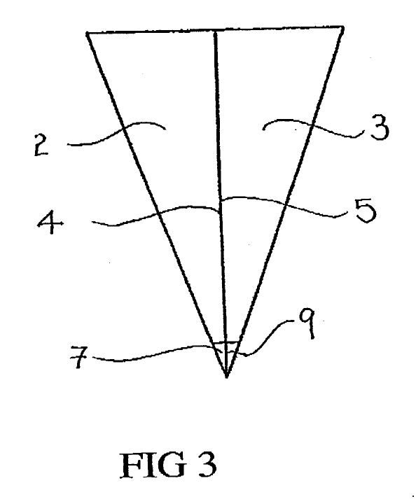

The distal end of each jaw 2 and 3 includes an arrowhead formation 7 and 8 each of which extends in the direction of elongation of the jaws. As is best shown in FIG. 3, when the jaws are in the first position, the tip of each arrowhead 7 and 8 is aligned with respective jaw abutment surfaces 4 and 5.

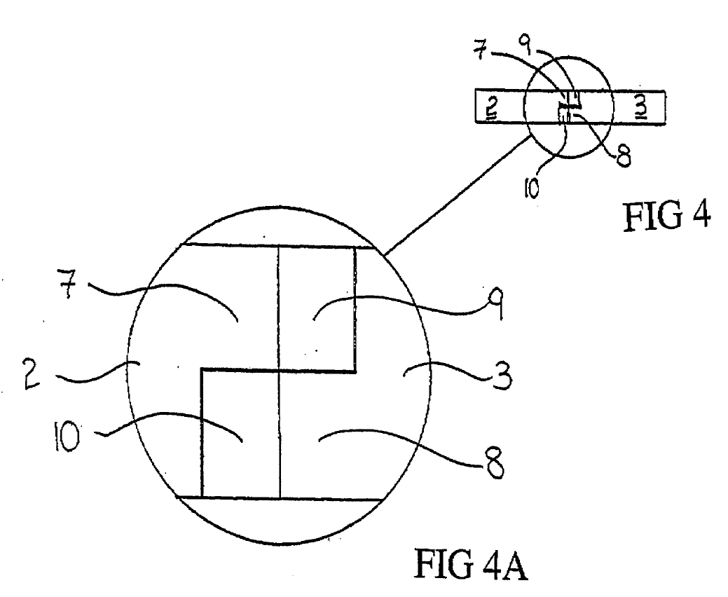

FIGS. 4 and 4A best illustrate the jaws in this position where portions 9 and 10 of arrowheads 7 and 8 overlap so that the tips overlie each other. Therefore, when in the first position the tip of each arrowhead 7 and 8 is substantially aligned with the abutment surfaces 4 and 5.

The arrowhead formation is configured to possess an acute angle of 17°, however, this is preferably within the range of 2° to 70°. The width of each arrowhead formation is preferably within the range of 0.3 to 7 mm.

A digital display 9 is attached to the proximal end the second jaw 3. The display is slidable with the jaw 3 along elongate stem 6. The relative movement of the jaw 3 is facilitated by a thumb wheel 11 rigidly connected to the display 9 and jaw 3. The jaw 3 can be releasably fixed with respect to the first jaw 2 by means of a grub screw 12.

The display 9 provides a digital indication of the distance of separation of the abutment surfaces 4 and 5 and hence arrowheads 7 and 8 which corresponds to the measured distance. The digital display 9 includes a reset 10 for selectively resetting the zero of the display to any desired separation of abutment surfaces 4 and 5. A memory means is also included in the display 9 for storing measured distances and is actuated by button 13. An on/off button 14 for actuating the digital display 9 is also included.

In alternative embodiments of the invention (not illustrated), the digital display 9 is not used and the calipers include a conventional vernier scale for providing an indication of the measured distance. In such embodiments, a first scale is disposed along the elongate stem 6 and a second scale disposed on the proximal end of the second jaw 3. The relative position of the first and second scales provides an indication of the distance the abutment surfaces 4 and 5 are separated.

In use, the measuring device is used to measure the distance between the centres of two objects such as holes, crevices, fissures, or edges or other object of interest. The tips of the arrowhead formations 7 and 8 each self-align with the centre of the hole, etc. to be measured. Since the tips align with the respective abutment surfaces 4 and 5, an accurate measure is provided of the distance between the centres, or from the edge, via digital display 9 or vernier scale in such embodiments.

In dentistry, the measuring device can be used to measure the distance between teeth or other measurements of interest to the dentist. In particular, the device 1 is particularly useful at measuring the distance between teeth edges, crevices or fissures, holes or other property of interest, which are most often small in magnitude.

Existing vernier or digital calipers can be modified to utilize the present invention as follows. The arrowhead formations 7 and 8 can be formed by adding or integrating (for example by welding or sintering) a predetermined volume of material onto the distal end of each jaw 2 and 3. Each volume of material deposited is then shaped (for example by grinding, milling or pressing) so as to define the arrowhead formations 7 and 8 where the tip of each arrowhead 7 and 8 is aligned with respective abutment surfaces 4 and 5. When the jaws 2 and 3 are moved to the first position (FIG. 3), the portions 9 and 10 of the arrowhead 7 and 8 overlap so that the tips overlie each other.

The step of shaping the arrowhead formations can be effected by grinding, machining and/or pressing the deposited volume of material.

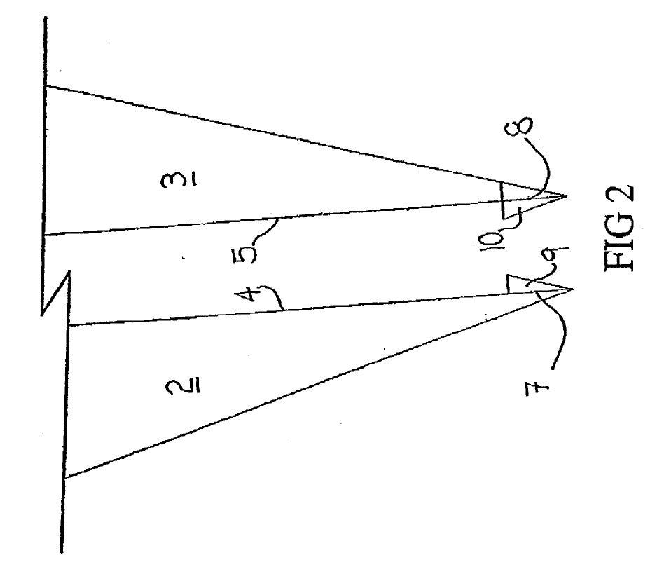

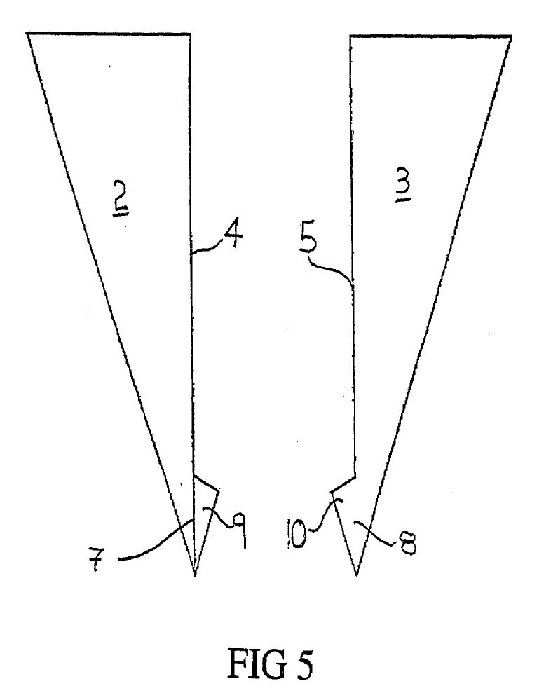

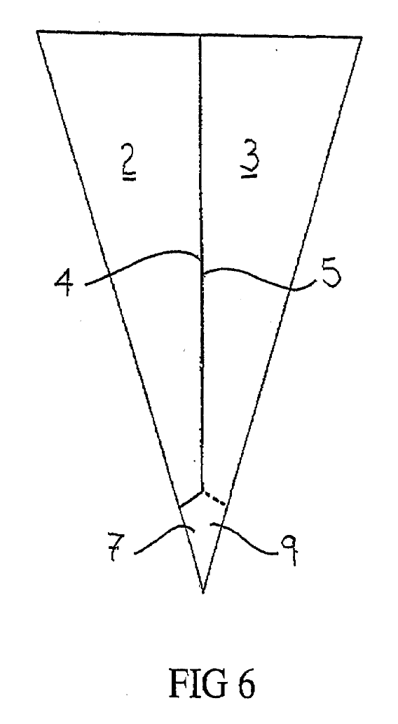

FIG. 5 illustrates another embodiment which is a plan view of the jaws in the second position. The arrowhead formations 7 and 8 of jaws 2 and 3 have tips which have a more acute angle than the embodiment of FIGS. 1 to 4A. The more acute the angle of the arrowhead formations 7 and 8 the more deeply the tips will self-align in holes, crevices, fissures, etc. FIG. 6 illustrates the jaws of this embodiment in the first position.

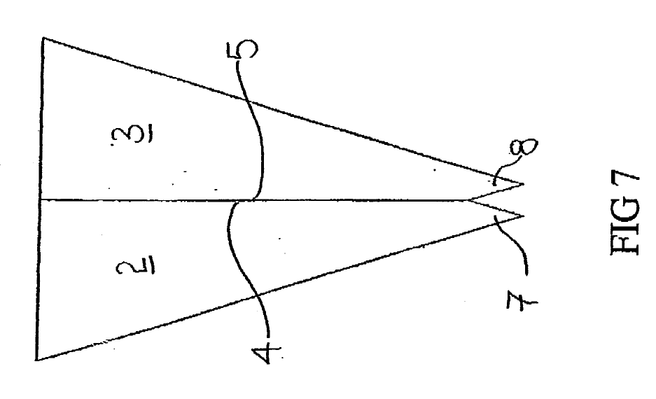

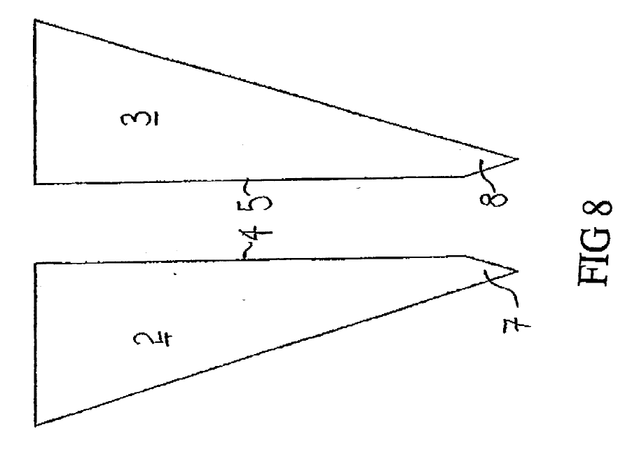

In FIGS. 7 and 8, there is illustrated a plan view of another embodiment in which the arrowhead tips 7 and 8 and abutment surfaces 4 and 5 are off-set from each other by a predetermined amount when the jaws are in the first position. The arrowhead tips 7 and 8 can be self-aligned in a hole, crevice, etc., and the off-set can be added to the distance the abutment surfaces 4 and 5 are displaced from each other when the jaws 2 and 3 are in the second position. The off-set of the arrowhead tips 7 and 8 can be compensated for automatically by configuring the vernier scale, digital display 9 or the like to add the off-set.

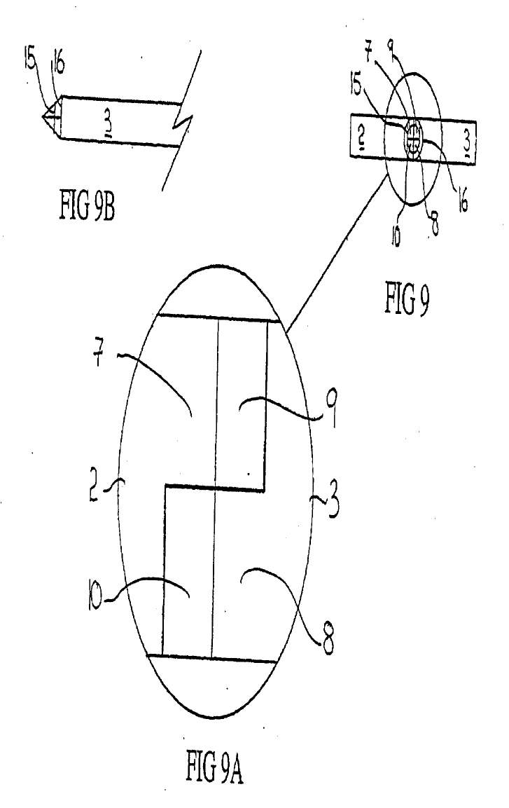

FIG. 9 illustrates a plan view of the jaws 2 and 3 in another embodiment. The jaws are shown in the first position when viewed from the end and the jaws 2 and 3 are configured to provide a general conical shape in this position. The portions 9 and 10 of arrowhead tips 7 and 8 overlie each other and the tips 7 and 8 are substantially aligned with the jaw abutment surfaces (not illustrated). FIG. 9A is an enlarged view of FIG. 9 illustrating the overlapping of the jaws.

FIG. 9B is a side view of the embodiment of FIGS. 9 and 9A showing the conical shape formed by the jaws 2 and 3 when in the first position. A first smaller radius 15 of the conical shape is defined from a predetermined distance from the tips 7 and 8 when the jaws are in the first position. A second larger radius 16 of the conical shape is provided along the tip wherein the radius 16 is spaced apart from the first radius 15.

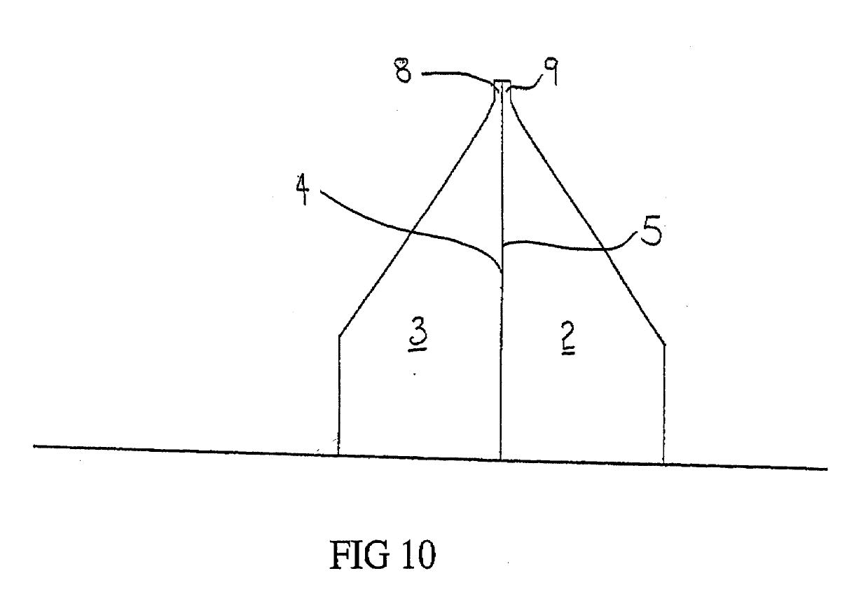

FIG. 10 illustrates an alternative embodiment in which the arrowhead tips 7 and 8 do not converges to sharp points. The points are slightly blunted perpendicular to the direction of elongation of the jaws and the arrowhead tips 7 and 8 each have a width which is very small in comparison to the dimensions of the jaws 2 and 3. In circumstances where the tips are slightly blunted and the holes, crevices, etc. to be measured are separated by large distances relative to a width of the tips created by the blunting, then accuracy will not be compromised by not having very sharp arrowhead tips 7 and 8.

The foregoing describes only some preferred embodiments of the present invention and modifications, obvious to those skilled in the art, can be made thereto without departing from the scope of the present invention. For example, the jaws can be hingedly connected at their proximal ends in the manner of a pair of dividers to provide movement of the jaws between the first and second positions. Furthermore, the measured distance may be indicated on the device by any other conventional means in addition to digital or vernier displays.

The term “comprising” as used herein is used in the inclusive sense of “including” or “having” and not in the exclusive sense of “consisting only of”.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A measuring device having a pair of elongate jaws each including an inner abutment surface, the jaws being movable between a first position wherein the inner abutment surface of the jaws are contiguous with each other and define a position of zero separation of the jaws and a second position wherein the jaws are displaced from each other, the distance the jaws being displaced from each other defining a measured distance, a distal end of each jaw of the measuring device having an arrowhead formation extending in the direction of elongation of the jaws wherein the tip of each arrowhead formation is aligned with a respective abutment surface and when the jaws are in the first position the arrowheads at least partially overlap so that the tips overlie each other.

2. A measuring device according to claim 1 wherein the arrowhead formation is configured to possess an acute angle substantially within the range of 2° to 70°.

3. A measuring device according to claim 2 wherein the acute angle is 17°.

4. A measuring device according to claim 1 wherein the width of each arrowhead formation is substantially within the range of approximately 0.3 mm to about 7 mm.

5. A measuring device according to claim 2 wherein the width of each arrowhead formation is substantially within the range of approximately 0.3 mm to about 7 mm.

6. A measuring device according to claim 1 in the form of a caliper wherein the proximal end of the jaws are attached to the caliper to allow the movement of the distal end of the jaws between the first and second positions.

7. A measuring device according to claim 1 including an elongate stem having the first jaw disposed at a first end, the jaw being substantially perpendicular to the direction of elongation of the stem and the second jaw being slidably mounted on the elongate stem to allow movement of the second jaw relative to the first jaw and between the first and second jaw positions.

8. A measuring device according to claim 6 including an elongate stem having the first jaw disposed at a first end, the jaw being substantially perpendicular to the direction of elongation of the stem and the second jaw being slidably mounted on the elongate stem to allow movement of the second jaw relative to the first jaw and between the first and second jaw positions.

9. A measuring device according to claim 7 having a vernier scale indicative of the measured distance, the device including a first scale being disposed on the elongate stem and a second scale being disposed on the proximal end of the second jaw, wherein the relative position of the first and second scales provides an indication of the measured distance.

10. A measuring device according to claim 7 including an elongate stem having the first jaw disposed at a first end, the jaw being substantially perpendicular to the direction of elongation of the stem and the second jaw being slidably mounted on the elongate stem to allow movement of the second jaw relative to the first jaw and between the first and second jaw positions.

11. A measuring device according to claim 8 including a digital display indicative of the measured distance.

12. A measuring device according to claim 1 wherein the arrowhead tips are each configured to be self-centring in a hole, crevice, fissure or the like wherein the measured distance is indicative of the distance between the centres of the hole, crevice, fissure or the like.

13. A measuring device according to claim 12 wherein the jaws provide a generally conical formation at their distal ends when in the first position.

14. A measuring device according to claim 1 used to measure predetermined properties of interest in dentistry.

15. A method of providing a dental tool comprising the steps of:
adding a predetermined volume of material on the distal end of an otherwise conventional jaw of a measuring device having a pair of elongated jaws including an inner abutment surface and being movable between a first position wherein the inner abutment surfaces are contiguous with each other and a second position wherein the jaws are displaced defining a measured distance;
shaping said volume of material to define an arrowhead formation wherein the tip of the arrowhead formation is aligned with the abutment surface of the jaw.

16. A method according to claim 15 wherein the step of shaping the volume of material to define the arrowhead is effected with one or more of the means selected from the group consisting of grinding, machining and pressing the volume.
